(19) United States
(12) Patent Application Publication
(10) Pub. No.: US 2014/0187326 A1
(43) Pub. Date: Jul. 3, 2014

(54) SYSTEM AND METHOD FOR SELECTING A WINDOW SIZE FOR A GAME ON AN AMUSEMENT DEVICE

(71) Applicant: MEGATOUCH, LLC, Bristol, PA (US)

(72) Inventor: William L. LAYNE, IV, Harleysville, PA (US)

(73) Assignee: MEGATOUCH, LLC, Bristol, PA (US)

(21) Appl. No.: 14/146,375

(22) Filed: Jan. 2, 2014

Related U.S. Application Data
(60) Provisional application No. 61/748,269, filed on Jan. 2, 2013.

(51) Int. Cl. A63F 13/20

(52) U.S. Cl. CPC A63F 13/06
USPC 463/31

(57) ABSTRACT

An amusement device system that permits selection of game board size for an amusement game includes a touchscreen display having a display width, a controller in communication with the touchscreen display and a memory in communication with the controller. The memory stores a plurality of games and a screen size graphical user interface having a first screen size option and a second screen size option. The controller is configured to send a signal to the touchscreen display to present the screen size graphical user interface during start-up of the amusement game.

### CROSS-REFERENCE TO RELATED APPLICATIONS

This application claims the benefit of U.S. Provisional Patent Application No. 61/748,269, filed on Jan. 2, 2013, entitled “System and Method for Selecting a Window Size for a Game on an Amusement Device,” the entire contents of which are incorporated herein by reference in their entirety.

### BACKGROUND OF THE INVENTION

Display screen sizes of amusement devices have increased in parallel with the increase in television display sizes. Certain users and players of the amusement devices prefer the smaller sized displays of previous versions of the amusement devices for multiple reasons.

Certain users find that the relatively larger display screens of recently released amusement devices result in the user or player having to move their hand further distances to play the game during touchscreen display game play. Many touchscreen games, and particularly tournament games of the amusement devices, have a time bonus that is given when users or players complete a task in a minimal amount of time. Accordingly, quick play is desirable to certain users and a half second difference in completing a task can be the difference between high placement in the game and low placement in the game. When the user or player has to move their hand a further distance to make a selection during the game on the touchscreen display, these additional movements and counterpart added times can detract from the player's scores, which correspond to their placement in tournaments.

The relatively larger display also requires user's or player's to visually “take in” more space on the display or visually process are larger area on the display. The player's eyes have to move further to see all the game play or game board and things that may have been in a player's peripheral vision on a relatively smaller display are now out of sight, thereby causing the player to potentially miss a move, lose a life, react slower to a game play scenario or otherwise become disadvantaged during gameplay due to the relatively larger size of the display or screen. Display sizes of the amusement devices have increased in recent times with the display sizes increasing from twelve inches (12″) to fifteen inches (15″) to seventeen inches (17″) to nineteen inches (19″), to twenty-two inches (22″) and potentially to larger sizes. These sizes may also include widescreen sizes, further increasing the display areas.

It is also often the case that a tournament will run on multiple amusement devices with each of the amusement devices having different sized displays. The different sized displays cause experienced players to seek out the relatively smaller sized displays so that they do not have to move their hands over the larger screens, do not have to visually scan and take in the relatively larger displays and for various other reasons. Certain players perceive the relatively larger displays as disadvantageous to their game play for these reasons, particularly in tournament games when they are competing against other tournament players utilizing various sized displays.

In addition, operators of amusement devices often upgrade their amusement devices by purchasing devices with the relatively larger displays or screens. The operators are aware that certain players that utilize their amusement devices find the amusement devices with the relatively larger displays disadvantageous to their game play. Accordingly, operators retain their dated or existing amusement devices along with the new amusement devices with the relatively larger displays to accommodate players who prefer the displays with smaller sizes. The relatively larger displays are often preferred by casual players who prefer the relatively large and clear image projected by the newer, relatively larger displays. Some operators, therefore, have an overabundance of amusement devices or more amusement devices at their facilities than they many necessarily require to accommodate multiple player preferences. This overstocking of amusement devices is disadvantageous for operators, as they must maintain amusement devices of various vintage, maintain extra floor space for the multiple amusement devices, maintain a gaming floor with amusement devices that are rarely all being utilized at one time and other related disadvantages.

While having a relatively smaller display size may benefit the tournament player, the relatively smaller display size is typically a disadvantage for the casual or recreational player. The casual or recreational player is typically not in a rush to complete a game and prefers the relatively larger display sizes, which include better graphics, upgraded display quality, larger game boards and other related advantages. A relatively smaller screen size is generally not utilized on an amusement device designed to be a “social” amusement device with a touchscreen display so that more than two players can play amusement games simultaneously. Such an amusement device having a relatively larger display is often considered a poor amusement device for tournament players.

Operators prefer to accommodate both casual and tournament users or customers and are forced to purchase multiple amusement devices and position them in the same location on a gaming floor to meet both sets of player's preferences. Such purchasing and storage of multiple amusement devices is expensive and prohibitive. Certain operators are forced to choose only a single amusement device to maintain at their facility, which is not preferred by at least one element of their potential players.

The present system and method for selecting a window size for a game on an amusement device addresses the above-described shortcomings of the various vintage amusement devices having multiple display sizes that are preferred by different types of players.

### BRIEF SUMMARY OF THE INVENTION

Briefly stated, a preferred embodiment of the present invention is directed to an amusement device system that permits selection of game board size for an amusement game. The amusement device includes a touchscreen display having a display width, a controller in communication with the touchscreen display and a memory in communication with the controller. The memory stores a plurality of games and a screen size graphical user interface having a first screen size option and a second screen size option. The controller is configured to send a signal to the touchscreen display to present the screen size graphical user interface during start-up of the amusement game. In the preferred embodiment, the first screen size option is a SMALL screen size option and the second screen size option is a LARGE screen size option.

In another aspect, another preferred embodiment of the present invention is directed to a method for selecting a game board size for an amusement game on an amusement device when a user initiates play of the game. The amusement device includes a controller, a memory, a currency input component and a touchscreen display. The method includes receiving, at the currency input component, a minimum currency amount to initiate play of the game; automatically displaying, on the touchscreen display, a screen size graphical user interface including a first screen size option and a second screen size option; receiving, at the controller, a signal from the touchscreen display of a first selection or a second selection; and automatically displaying, on the touchscreen display, a first width if the first selection is received or a second width on the touchscreen display if the second selection is received. In the preferred embodiment, the first width is a SMALL width and the second width is a comparatively LARGE width.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1A is a front perspective view of an amusement device in accordance with a first preferred embodiment of the present invention;

FIG. 1B is a front perspective view of an amusement device in accordance with a second preferred embodiment of the present invention;

FIG. 1C is a front perspective view of an amusement device in accordance with a third preferred embodiment of the present invention;

FIG. 2 is a schematic block diagram of an amusement system including a currency input in accordance with preferred embodiments of the present invention that may incorporate any of the preferred amusement devices of FIGS. 1A-1C;

FIG. 3 is a screenshot of a display of any of the preferred amusement devices of FIGS. 1A-1C showing a screen size graphical user interface in accordance with a preferred embodiment of the present invention;

FIGS. 4A-4C are screenshots of a display for Game A game of the preferred amusement devices of FIGS. 1A-1C, showing a second or large game board size in FIG. 4A, a third or medium game board size in FIG. 4B and a first or small game board size in FIG. 4C; and

FIGS. 5A-5C are screenshots of a display for a Game B menu of the preferred amusement devices of FIGS. 1A-1C, showing a second or large field size in FIG. 5A, a third or medium field size in FIG. 5B and a first or small field size in FIG. 5C.

### DETAILED DESCRIPTION OF THE INVENTION

Certain terminology is used in the following description for convenience only and is not limiting. Unless specifically set forth herein, the terms “a”, “an” and “the” are not limited to one element but instead should be read as meaning “at least one”. The words “right,” “left,” “lower,” and “upper” designate directions in the drawings to which reference is made. The words “inwardly” or “distally” and “outwardly” or “proximally” refer to directions toward and away from, respectively, the geometric center or orientation of the device and related parts thereof. The terminology includes the above-listed words, derivatives thereof and words of similar import.

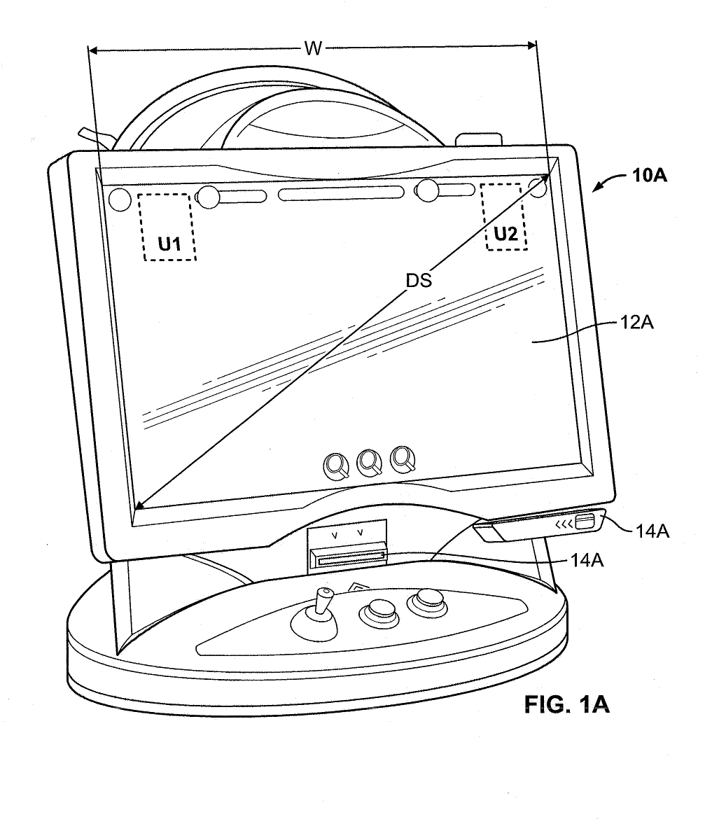

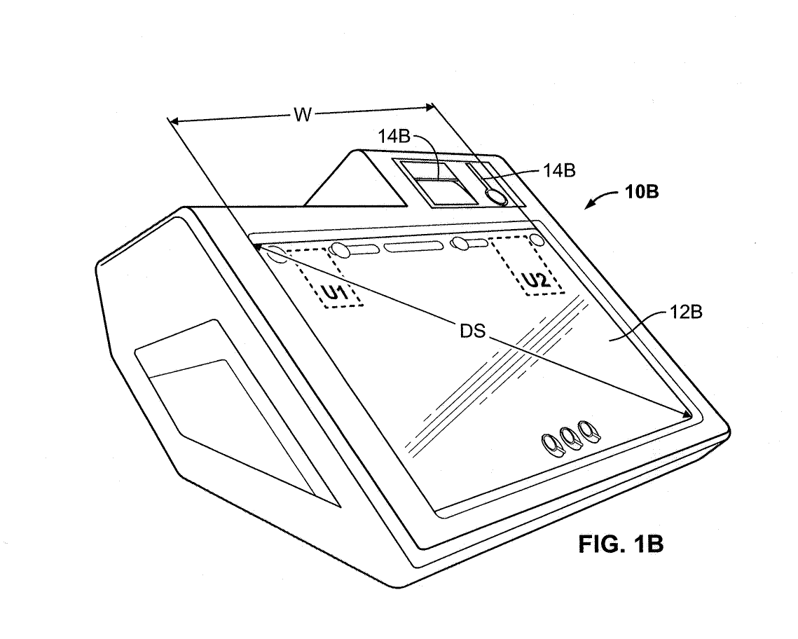

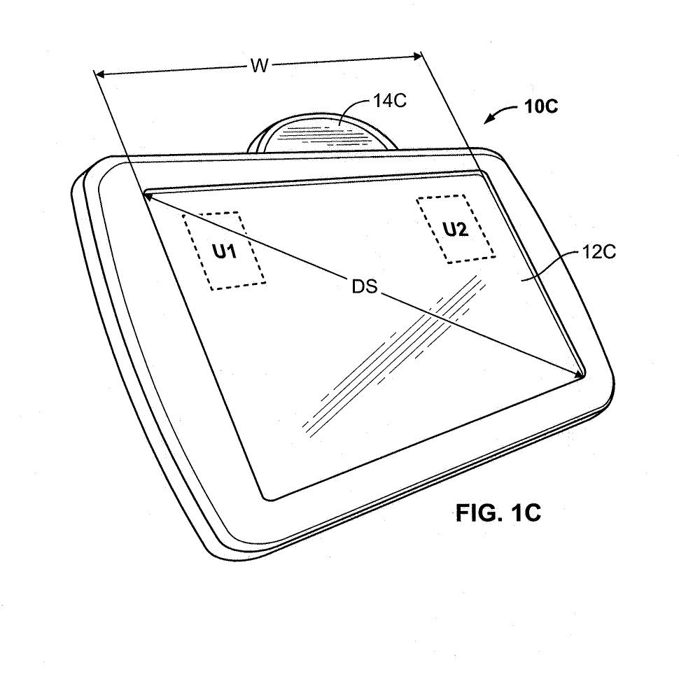

Referring to the drawings in detail, wherein like reference numerals indicate like elements throughout, there is shown in FIG. 1A a first preferred embodiment of an amusement device 10A. The amusement device 10A includes a controller U1 and a memory U2. The memory U2 can be any known or suitable memory device such as random access memory (RAM), read only memory (ROM), flash RAM, hard disk, optical disk, or the like. The amusement device 10A further includes a video display 12A that is operatively connected to the controller U1. The video display 12A has a display width W and a diagonal span DS, which may be approximately twelve inches (12″), fifteen inches (15″), seventeen inches (17″), nineteen inches (19″) or twenty-two inches (22″), with the earliest or vintage models being twelve inches (12″) and more recent models being twenty-two inches (22″). The preferred display width W and diagonal span DS are not limited to these specific dimensions and may be comprised of nearly any width or diagonal span that a manufacturer is able construct, with the above-listed dimensions being generally conventional in the current marketplace. The amusement device 10A is preferably a counter-top or table-top apparatus, but may be arranged in any configuration, such as free-standing, floor-standing, table mount, wall mount, pole mount, and the like without departing from the invention.

The first preferred amusement device 10A also includes at least one currency input component 14A that receives value in order to establish one or more playable credits. The value received may be at least one of currency, coins, tokens, chits, credits, credit cards/debit cards or the like. Although two currency input components 14A are shown, the amusement device 10A may include any number of currency input components 14A to give the user an option for payment, for permitting multiple players, or the like. Preferably, the amusement device 10A is made operable upon actuation of the currency input component 14A, for example, the user may only select and play an electronic game once a minimum value or minimum currency amount is received at the currency input component 14A and/or one or more playable credits are issued to the user. However, free selections may be offered at the discretion of an operator of the amusement device 10A.

FIG. 1B shows another or second amusement device 10B in accordance with a second preferred embodiment of the present invention. The second amusement device 10B also includes a controller U1, a memory U2, a video display 12B, and at least one currency input component 14B. Preferably, the video displays 12A, 12B are touchscreen video displays configured to accept touch input, but are not so limited. The touchscreen video displays 12A, 12B of the first and second preferred embodiments comprise input portions 12A, 12B that are in communication with the controller U1 to provide interaction between the user and the amusement device 10A, 10B and are used to direct the game play. The amusement devices 10A, 10B are not limited to touchscreen video displays 12A, 12B for their input portions 12A, 12B, which may comprise keyboards, mice, trackballs, wands or other input devices that permit signaling from the user to the controller U1 or the amusement device 10A, 10B.

FIG. 1C shows yet another or third amusement device 10C in accordance with a third preferred embodiment of the present invention. The third amusement device 10C is a portable device, preferably battery-powered, and includes a controller U1, a memory U2, a display 12C, and at least one currency input component 14C. The third amusement device 10C is preferably usable with a docking station (not shown). The docking station preferably secures the amusement device 10C until access is required by an operator or is paid for by a user. Release from the docking station may occur via an entry of a minimum currency release amount through the currency input component 14C, which is preferably a card reader. The docking station may also provide battery recharging, software downloads and other services to the amusement device 10C.

For convenience, the amusement devices 10A, 10B, 10C will be referred to hereinafter simply as “amusement device 10,” the displays 12A, 12B, 12C will be referred to hereinafter simply as “display 12,” and the currency input components 14A, 14B, 14C will be referred to hereinafter simply as “currency input component 14.”

Turning now to the operation of the amusement device 10, the memory U2 stores one or more application programs, such as electronic games, a music or video jukebox program, or the like, and a system control program. However, the one or more application programs may also be stored remotely. The controller U1 controls the touchscreen display 12 based upon the system control program retrieved from the memory U2 and based upon inputs from the touchscreen display 12 or other input portion 12, such as keyboards, trackballs, mice or related input devices or hardware. As used herein, the system control program refers to all of the software functions outside of the application program files including an operating system, device profile, display control, input control, sound drivers, and the like. Other input portions 12 which may be connected to the amusement device 10 include a pushbutton(s), a trackball or touchpad, a mouse, a joy-stick, a foot-pedal, a voice recognition system, a keypad or keyboard, and the like. But, preferably, the input portion 12 is comprised of the touchscreen display 12.

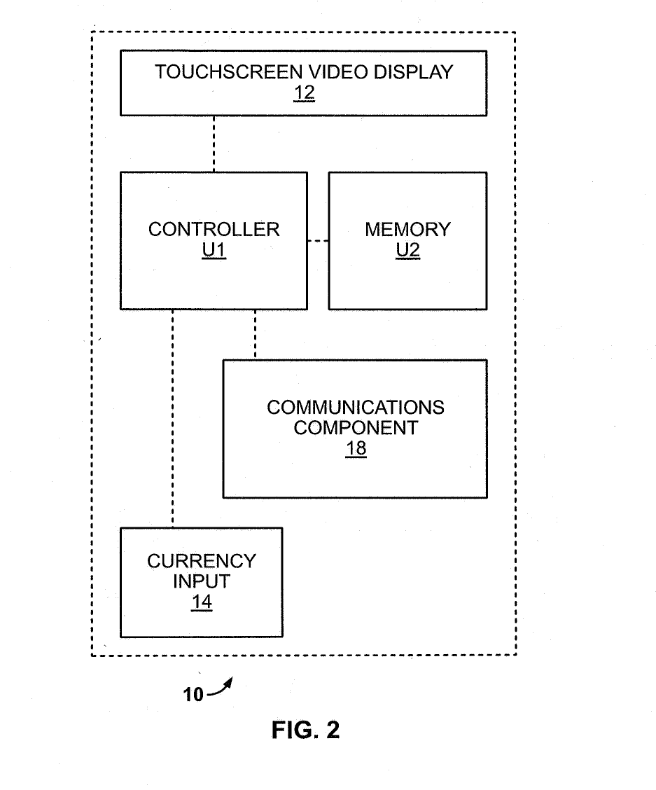

FIG. 2 is a schematic block diagram of the amusement device 10. The touchscreen display 12 is coupled to the controller U1. Also coupled to the controller U1 is the currency input component 14. The currency input component 14 may accept at least one of coins (or tokens), currency (e.g. paper money or the like), credit cards/debit cards, and the like. Although only one currency input component 14 is shown, the amusement device 10 may include more than one currency input component 14 to give a user an option for payment, for permitting multiple players, or the like. Preferably, the amusement device 10 is made operable upon payment by a user, which may optionally be received via the currency input component 14.

The amusement device 10 also includes a communications component 18, such as an Ethernet port, a wireless transceiver, an infrared (IR) port, or the like. Using the communications component 18, the amusement device 10 may communicate with other devices or file servers, access the Internet, communicate over wide area networks (WANs) or local area networks (LANs), or the like. For example, the amusement device 10 may connect with a second amusement device (not shown) using the communications component 18. The second amusement device optionally includes all of the same components and features as the amusement device 10. The communications component 18 is connected to the controller U1 and through the controller U1 to the memory U2. The amusement device 10 preferably includes an operating mode and a setup mode. To switch from the operating mode to the setup mode, when an operator is present at the amusement device 10, a mode selector pushbutton (hardware not shown) is provided that is typically concealed from the users. The mode selector pushbutton may be implemented as a hidden software feature, but preferably the mode selector pushbutton is a simple pushbutton that is disposed inside a housing of the amusement device 10. When the operating mode is selected, a player or user is selectively permitted to access the application programs. When the setup mode is selected, the owner/operator is permitted to make system setup adjustments.

Each amusement device 10 has a plurality of system configuration settings that may be adjusted to alter the operation or appearance of the amusement device 10. The configuration settings are set by an owner/operator based on factors such as the local laws, business needs and judgment of the amusement device 10 owner/operator. The configuration settings of each amusement device 10 may be set independently of one another. However, where an owner/operator controls a large number of amusement devices 10, it is preferable to quickly and easily configure a plurality of amusement devices 10 with common configuration settings. For example, an owner/operator may want all amusement devices 10 deployed at bars to have a first common configuration and all amusement devices 10 deployed at family restaurants to have a second common configuration. In accordance with the present invention, an operator account is maintained for each owner/operator at a central location accessible over a network. The owner/operator may configure one or more configuration settings profiles in the operator account and assign amusement devices 10 to the one or more settings profiles. The configuration settings are then automatically managed for all assigned amusement devices 10 by the central location.

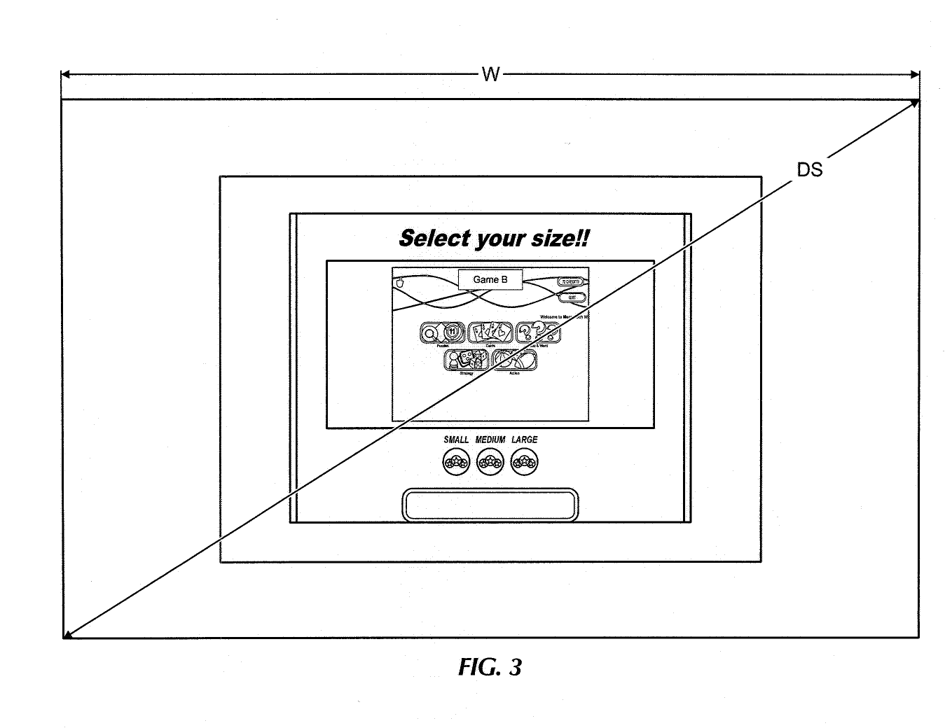

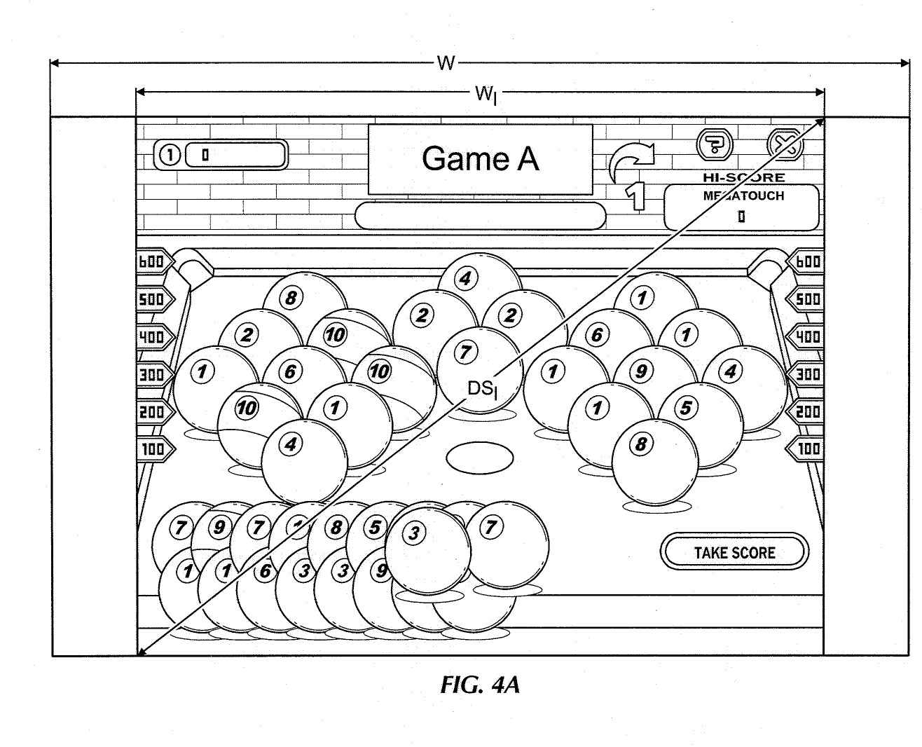

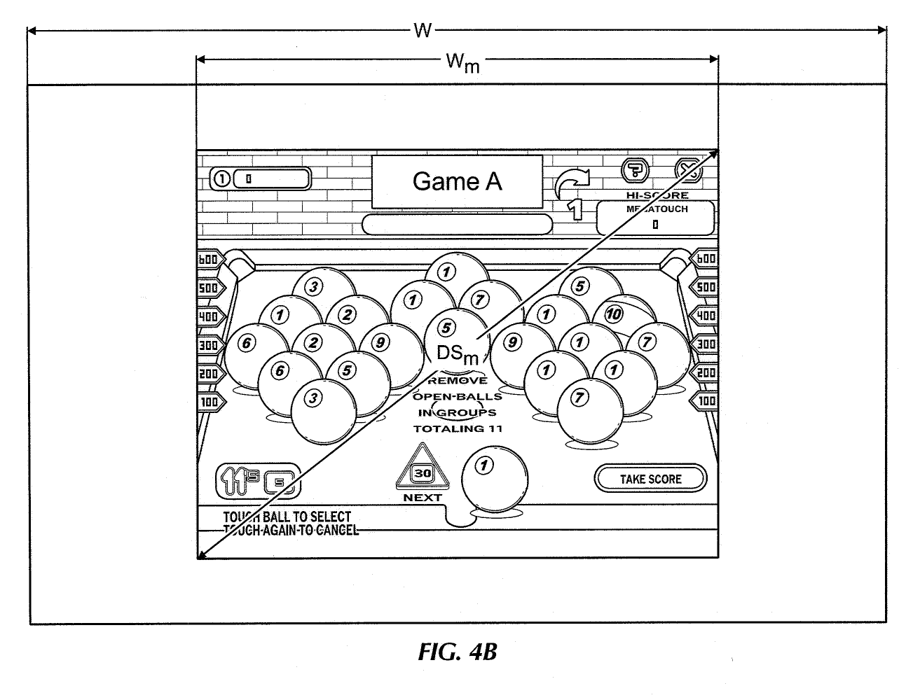

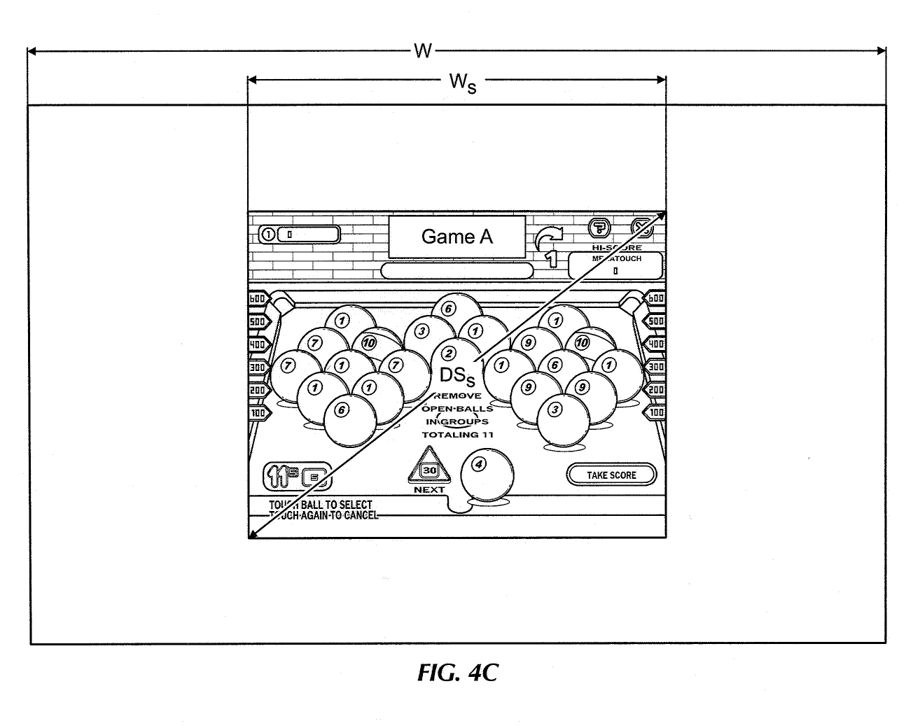

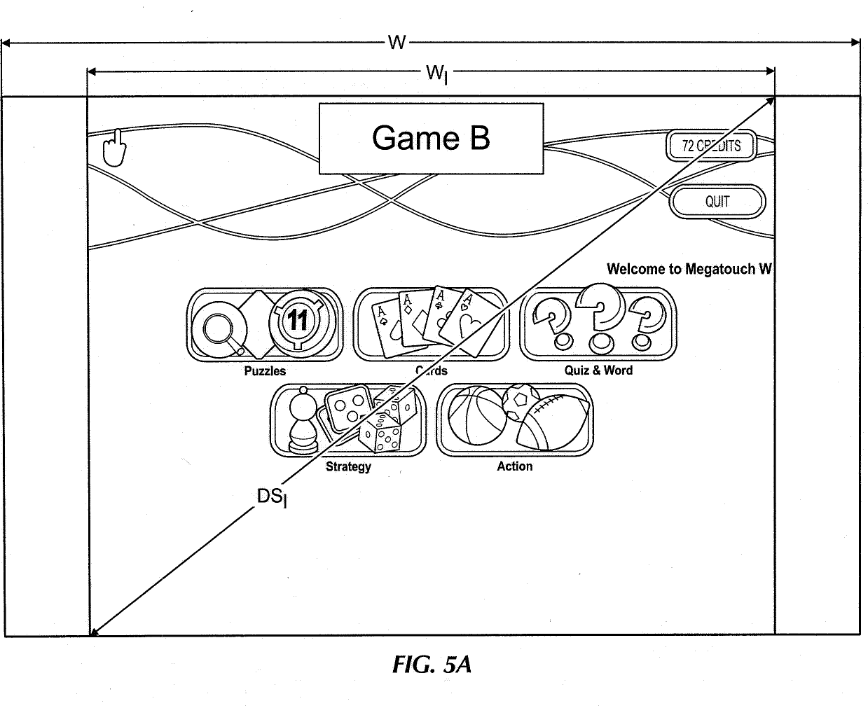

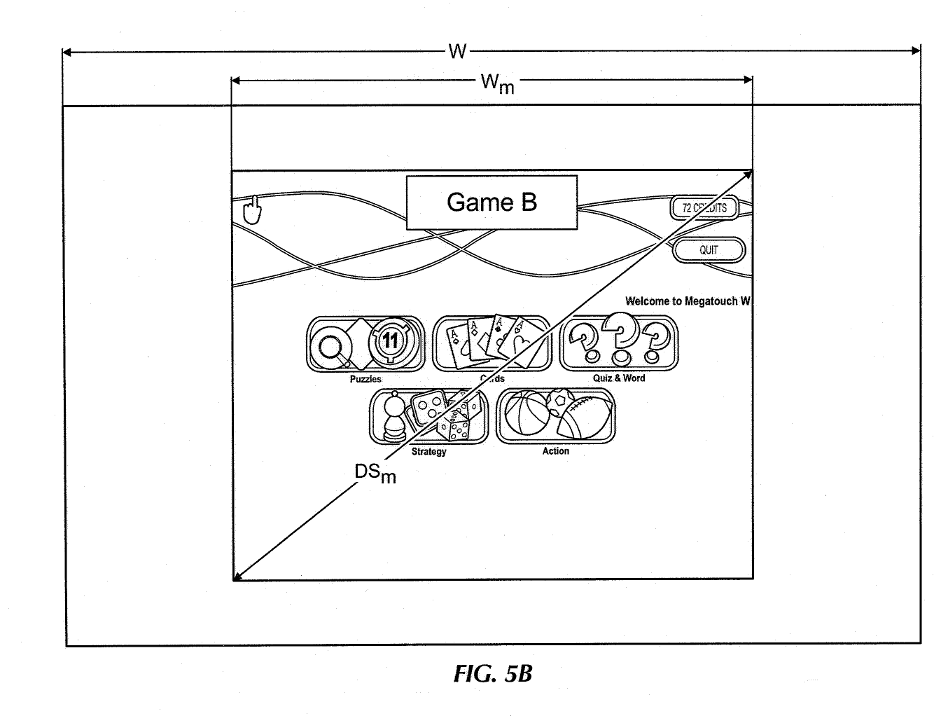

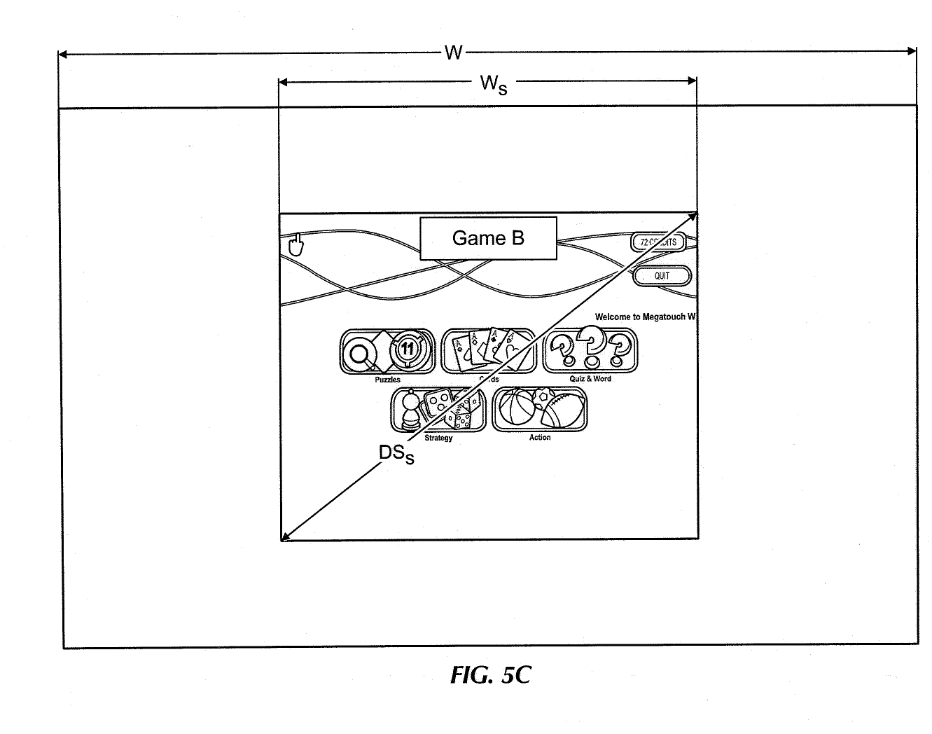

Referring to FIGS. 1A-5C, the display 12 of the amusement devices 10 of the preferred invention are the relatively largest displays 12 that are currently available. For example, the displays 12 may each have the display width W or diagonal span DS of twenty-two inches (22″) for the preferred version of the amusement devices 10, but are not so limited and may be larger or smaller. In the preferred amusement devices 10, the games are played on the displays 12 having the display width W or diagonal span DS of twenty-two inches (22″) and the displays 12 are preferably touchscreen displays 12. The displays 12 preferably present images in a 4:3 aspect ratio and the display 12 itself preferably has an aspect ratio of 16:10, but neither is so limited and the displays 12 may have nearly any aspect ratio that is preferred by the players or operators. In the preferred display 12, a large width Wₗ of the playing field or board is approximately fourteen and three-quarters inches (14¾″) and a large diagonal span DSₗ of the playing field or board is approximately nineteen inches (19″), as will be described in further detail below. The casual players often prefer the additional size and clarity provided by the large width Wₗ and the large diagonal span DSₗ for the game board or field on the display 12, while the tournament player often finds the large width Wₗ and the large diagonal span DSₗ for game board or field on the display 12 a disadvantage. The tournament player will often seek out earlier versions or vintage amusement devices 10 having the relatively smaller display width W and diagonal span DS for the display 12, such as the displays 12 having the display widths W or diagonal spans DS of twelve, fifteen, seventeen or nineteen inches (12″, 15″, 17″ or 19″) such that the width and diagonal span DS of the game board or field is smaller during game play, thereby providing the advantages described above for the tournament player.

The preferred system and method of the amusement devices 10 of the present invention presents a screen size graphical user interface (“GUI”) 20 to the user or player when the player initiates game play. The screen size GUI 20 offers the player multiple screen size options 20a, 20b, 20c for selection depending upon their game playing preferences. In the preferred embodiment, the screen size GUI 20 offers the player a first or SMALL screen size option 20a, a third or MEDIUM screen size option 20b and a second or LARGE screen size option 20c. When utilizing the display 12 having the display width W or diagonal span DS of twenty-two inches (22″), a first or SMALL width Wₛ on the display 12 resulting from selection of the first or SMALL screen size option 20a is approximately nine and one-half inches (9½″) with a first or SMALL diagonal span DSₛ of approximately eleven and three-quarters inches (11¾″), a third or MEDIUM width Wₘ from selection of the third or MEDIUM screen size option 20b is approximately eleven and one-half inches (11¾″) with a third or MEDIUM diagonal span DSₘ of approximately fourteen and one-quarter inches (14¾″) and a second or LARGE width Wₗ from selection of the second or LARGE screen size option 20c is approximately fourteen and three-quarters inches (14¾″) with a second or LARGE diagonal span DSₗ of approximately nineteen inches (19″) for the preferred displays 12 having the preferred aspect ratio of 4:3. Such game field or board widths are preferred for the twenty-two inch (22″) sized displays 12, but are not meant to be limiting and the first or SMALL, third or MEDIUM and second or LARGE widths Wₛ, Wₘ, Wₗ and the first or SMALL, third or MEDIUM and second or LARGE diagonal spans DSₛ, DSₘ, DSₗ may have nearly any dimension that is limited only by the size of the available displays 12 and the preferences of the players and users. The players will be able to select their preferred display size when they enter each of the games, thereby allowing the operators to maintain a consistent vintage of amusement device 10 at their facility and accommodate preferences of both the casual and tournament players. The more selective players are also able to select different game board or field widths for particular games, where they detect an advantage to having a smaller or larger game board or field width. For example, a tournament player may select the LARGE width for a driving game where obstacles are more easily detected at a distance so that they can be avoided with the larger game board or field and may alternatively select the SMALL width Wₛ and SMALL diagonal spans DSₛ for the game board or field when playing a photo hunt game to reduce the distance their hand must travel over the display 12 to select areas on the touchscreen display 12 and such that they can readily visualize the entire game board.

In the preferred embodiment, the tournament player may select the first or SMALL screen size option 20a resulting in the first or SMALL width Wₛ and the first or SMALL diagonal span DSₛ for the game board so that they do not have to move their hand extra distances while playing certain games on the preferred touchscreen displays 12 and are generally able to visually scan the entire game playing surface quickly and easily. The casual player may alternatively select the second or LARGE screen size option 20c resulting in the second or LARGE width Wₗ and the second or LARGE diagonal span DSₗ for the game board to view the relatively large game board or playing surface that the casual player perceives as easier to view. In addition, a player may select the third or MEDIUM screen size option 20b resulting in the third or MEDIUM width Wₘ and the third or MEDIUM diagonal span DSₘ for the game board for certain games, wherein the medium sized game board is perceived as an advantage for game play. In addition, players that are playing a game in parallel may elect to select the size of the game board to handicap the game. For example, a more skilled player may elect to select the second or LARGE screen size option 20c for a game where the first or SMALL screen size option 20a is perceived as advantageous when playing against a player who is less skilled, while the less skilled player selects the first or SMALL screen size option 20a for the same game in order to handicap the game.

Although the screen size GUI 20 is generally considered an accommodation of the preferences of tournament players and is included in a game start-up, particularly for tournament-type games, the screen size GUI 20 is not so limited. The screen size GUI 20 may be included in the game start-up of classic games or games that are not typically associated with tournament-type settings.

In use, the screen size GUI 20 appears or pops-up during the start-up of a particular game on the display 12. A tournament player, who may be targeting a specific goal during game play and could possibly benefit from a selectable screen size to get to the top of the leaderboards, earn a specific system challenge or to complete an object they set for themselves, selects their preferred screen size from the first or SMALL, third or MEDIUM and second or LARGE screen size options 20a, 20b, 20c on the screen size GUI 20. For example, the tournament player who does not want to move their hand extra distances over the display 12 having the twenty-two inch (22″) display width W or diagonal span DS, desires to take-in the entire game board with a single view and is accustomed to viewing the game board on a relatively small vintage display 12, such as the display 12 having the twelve inch (12″) display width W or diagonal span DS, may select the SMALL screen size option 20a, which may result in the game board having the first or SMALL width Wₛ of approximately nine and one-half inches (9½″) and the first or SMALL diagonal span of approximately eleven and three-quarters inches (11¾″). In contrast, the casual player, utilizing the same amusement device 10, is able to select the second or LARGE screen size option 20c during the game start-up resulting in the game board having the second or LARGE width Wₗ of approximately fourteen and three-quarters inches (14¾″) and the second or LARGE diagonal span DSₗ of approximately nineteen inches (19″) so that they receive the relatively larger images on the display 12 that may have a higher image quality and are easier for the casual player to perceive. The tournament player may also find that certain games become easier or goals or objectives are easier for them to attain when utilizing a larger game board and, therefore, the tournament player may also select the LARGE screen size option 20c or the third or MEDIUM screen size option 20b to obtain certain advantages during game play. Regardless, the screen size GUI 20 permits an operator to stock and utilize the same size and/or model of amusement devices 10 having the same sized displays 12, while also accommodating the various player preferences that were described above.

The preferred screen size GUI 20 permits selectable game board or field widths Wₛ, Wₘ, Wₗ and diagonal spans DSₛ, DSₘ, DSₗ and accommodates both tournament players, casual players, social groups of player, players who appreciate the “classic” smaller displays, players who appreciate the big display 12 that accommodates large game boards and players who appreciate high-definition (“HD”) graphics, all on the same amusement device 10. The operator who utilizes the preferred amusement devices 10 with the screen size GUI 20 generally will not have to purchase multiple models of amusement devices 10 having various sized displays 12 and the selectability will help drive player preference towards new amusement devices 10 instead of driving the operators and tournament players back to the vintage amusement devices 10 having the smaller displays 12 for their perceived advantages.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. An amusement device system that permits selection of game board size for an amusement game, the system comprising:
a touchscreen display having a display width;
a controller in communication with the touchscreen display; and
a memory in communication with the controller, the memory storing a plurality of games and a screen size graphical user interface having a first screen size option and a second screen size option, the controller configured to send a signal to the touchscreen display to present the screen size graphical user interface during start-up of the amusement game.

2. The amusement device system of claim 1, wherein the screen size graphical user interface also includes a third screen size option.

3. The amusement device system of claim 1, wherein one of the display width and diagonal span is approximately twenty-two inches (22″).

4. The amusement device system of claim 1, wherein the touchscreen display has an aspect ratio of 4:3.

5. The amusement device system of claim 4, wherein a first width of a game board of the game is approximately nine and one-half inches (9¾″) and a first diagonal span is approximately eleven and three-quarters inches 11¾″) when the first screen size option is selected.

6. The amusement device system of claim 4, wherein a second width of a game board of the game is approximately fourteen and three-quarters inches (14¾″) and a second diagonal span is approximately nineteen inches (19″) when the second screen size option is selected.

7. The amusement device system of claim 4, wherein a third width of a game board of the game is approximately eleven and one-half inches (11½″) and a third diagonal span is approximately fourteen and one-quarter inches (14¼″) when a third screen size option is selected.

8. The amusement device system of claim 1, wherein the first screen size option is a SMALL screen size option and the second screen size option is a LARGE screen size option.

9. The amusement device system of claim 1, wherein the screen size graphical user interface also includes a third screen size option, the third screen size option being a MEDIUM screen size option.

10. A method for selecting a game board size for an amusement game on an amusement device when a user initiates play of the game, the amusement device including a controller, a memory, a currency input component and a touchscreen display, the method comprising:
a) receiving, at the currency input component, a minimum currency amount to initiate play of the game;
b) automatically displaying, on the touchscreen display, a screen size graphical user interface including a first screen size option and a second screen size option;
c) receiving, at the controller, a signal from the touchscreen display of one of a first selection and a second selection; and
d) automatically displaying, on the touchscreen display, a first width if the first selection is received in step (c) and a second width on the touchscreen display if the second selection is received in step (c), respectively.

11. The method of claim 10, wherein the first width is approximately nine and one-half inches (9½″).

12. The method of claim 10, wherein the second width is approximately fourteen and three-quarters inches (14¾″).

13. The method of claim 10, further comprising:
e) displaying, on the touchscreen display, a third screen size option in step (b);
f) receiving, at the controller, a signal from the touchscreen display of a third selection; and
g) automatically displaying, on the touchscreen display, a third width.

14. The method of claim 13, wherein the third width is approximately eleven and one-half inches (11½″).

15. The method of claim 13, wherein the first screen size option is a SMALL screen size option, the second screen size option is a LARGE screen size option and the third screen size option is a MEDIUM screen size option.
